(19) United States
(12) Patent Application Publication
(10) Pub. No.: US 2023/0363392 A1
(43) Pub. Date: Nov. 16, 2023

(54) ANTI-MICROBIAL COMPOSITION

(71) Applicant: UWM Research Foundation, Inc., Milwaukee, WI (US)

(72) Inventors: Junjie Niu, Whitefish Bay, WA (US); Melvin Samuel Samuel Jayakumar, Milwaukee, WI (US)

(21) Appl. No.: 18/197,791

(22) Filed: May 16, 2023

Related U.S. Application Data
(60) Provisional application No. 63/342,495, filed on May 16, 2022.

(51) Int. Cl. A01N 45/00; A01N 59/00; A01N 35/02; A01N 25/10; A01P 1/00; A01N 25/34; C09D 5/14; C09D 7/63; C09D 163/00; C02F 1/50

(52) U.S. Cl. CPC A01N 45/00; A01N 59/00; A01N 35/02; A01N 25/10; A01P 1/00; A01N 25/34; C09D 5/14; C09D 7/63; C09D 163/00; C02F 1/505; C08K 5/09

(57) ABSTRACT

An antimicrobial composition comprising lithocholic acid, zinc pyrithione, cinnamaldehyde and a matrix forming compound. The composition is particularly suitable for treatment of microbial contamination and the formation of biofilms.

### CROSS-REFERENCE TO RELATED APPLICATIONS

This application claims the benefit of and priority from U.S. Provisional Application No. 63/342,495 filed May 16, 2022, which is fully incorporated herein by reference.

### GOVERNMENT SUPPORT CLAUSE

This invention was made with government support under grant 1540032 awarded by the National Science Foundation. The government has certain rights in the invention.

### FIELD

The present invention is directed at an anti-microbial composition. The composition includes lithocholic acid, zinc pyrithione and cinnamaldehyde. The composition may be applied in the form of a coating or in the form of a bead. The composition has particular utility to prevent bacteria adhesion to various water device surfaces such as stainless steel and glass.

### BACKGROUND

Microbial contamination in drinking water is a long-existing issue, which poses high risk in human's health. Even though current technology can remove most of mainstream microorganisms in water, the accumulated bacteria and biofilm on device surfaces still show a big challenge. It has been reported that 90% of the biofilms attach to the surfaces of pipelines, walls and only 5% of them are suspended in the drinking water distribution system (DWDS). Biofilm is a community of microorganisms formed in water environments such as the surfaces of sinks, toilets, and pipelines, which causes most of the hospital-acquired infections and pathogen outbreaks. It has been found the major pathogens in DWDS include Escherichia coli, Giardia lamblia, and Cryptosporidium parvum (gastroenteritis). Biofilm can establish a physical barrier consisting of extracellular polymeric substances that affect the efficacy of antimicrobial agents such as antibiotics. The physical method to remove biofilm is not accessible in indwelling medical devices, industrial pipelines, and drainage devices. The other disinfection approaches such as chemical treatments by using surfactants, chlorine, hydrogen peroxide and antibiotics will introduce more contaminations.

Accordingly, a need exists to identify improved compositions for the reduction, prevention and elimination of microbial contamination and biofilms.

### SUMMARY

An antimicrobial composition comprising lithocholic acid, zinc pyrithione, cinnamaldehyde and a matrix forming compound.

A method of preventing or reducing the accumulation of biofilm on a surface, the method comprising coating the surface with an antimicrobial composition comprising lithocholic acid, zinc pyrithione, cinnamaldehyde and a matrix forming compound.

A method of treating water comprising contacting water with a composition comprising lithocholic acid, zinc pyrithione, cinnamaldehyde in a matrix forming compound.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A provides a confocal optical microscopy image of a formed biofilm on stainless steel with E. coli.

FIG. 1B provides a confocal optical microscopy image of a formed biofilm on stainless steel with E. faecalis.

FIG. 1C provides a 3D image of a formed biofilm on stainless steel with E. coli.

FIG. 1D provides a 3D image of a formed biofilm on stainless steel with E. faecalis.

FIG. 1E shows the SEM morphology of a formed biofilm with E. coli on glass.

FIG. 1F shows the SEM morphology of E. faecalis on stainless steel.

FIG. 1G shows the SEM images of an uncoated polyethylene substrate.

FIG. 1H show the SEM image of a spray coated polyethylene substrate with lithocholic acid, zinc pyrithione and cinnamaldehyde.

FIG. 1I provides Fourier Transform Infrared Spectroscopy of the identified coating.

FIG. 2A shows the inside of a silicon hose before treatment.

FIG. 2B shows the biofilm of E. coli inside a silicon hose.

FIG. 2C shows the biofilm of E. faecalis inside a silicon hose.

FIG. 2D shows the absence of formation of biofilm inside a silicon hose coated with lithcholic acid, zinc pyrthione and cinnamaldehyde.

FIG. 3 shows the antibacterial performance of the LCA-Zn-CN coating with E. coli.

FIG. 4 shows the antibacterial performance of the LCA-Zn-CN coating with E. faecalis.

FIG. 5 shows the antibacterial activity to E. coli of the LCA-Zn-CN coating on a commercial water meter.

FIG. 6 shows the antibacterial activity to E. faecalis of the LCA-Zn-CN coating on a commercial water meter.

FIG. 7 shows batch testing of the LCA-Zn-CN beads against E. coli.

FIG. 8 shows batch testing of the LCA-Zn-CN beads against E. faecalis.

FIG. 9 shows continuous column testing of the LCA-Zn-CN beads against E. coli.

FIG. 10 shows continuous column testing of the LCA-Zn-CN beads against E. faecalis.

FIG. 11 shows antimicrobial activity of the LCA-Zn-CN coating against E. coli in natural water.

FIG. 12 shows antimicrobial activity of the LCA-Zn-CN coating against E. faecalis in natural water.

FIG. 13 shows antimicrobial activity in a batch study of LCA-Zn-CN beads against E. coli.

FIG. 14 shows antimicrobial activity in a batch study of LCA-Zn-CN beads against E. faecalis.

FIG. 15 shows antimicrobial activity in column testing of the LCA-Zn-CN beads against E. coli.

FIG. 16 shows antimicrobial activity in column testing of the LCA-Zn-CN beads against E. faecalis.

FIG. 17 shows durability testing of the LCA-Zn-CN coating.

FIG. 18 shows coating morphology of the LCA-Zn-CN coating before abrasion.

FIG. 19 shows coating morphology of the LCA-Zn-CN coating after abrasion.

FIG. 20 shows antibacterial testing using the JIS Z2801/ISO 22196 measurement for the LCA-Zn-CN coating.

FIG. 21 shows antimicrobial testing using the JIS Z2801/ISO 22196 measurement for E. coli on stainless steel and glass.

FIG. 22 shows the antimicrobial testing using the JIS Z2801/ISO 22196 measurement for E. faecalis on stainless steel and glass.

### DETAILED DESCRIPTION OF THE PREFERRED EMBODIMENTS

The present invention provides a composition that provides anti-microbial activity and bacteria adhesion to various water device surfaces, including the prevention or reduction in the accumulation of biofilm. The composition comprises, consists essentially of, or consists of three ingredients: lithocholic acid, zinc pyrithione and cinnamaldehyde. The composition is preferably in the form of a coating wherein the three ingredients are preferably dispersed in a polymer resin. The composition may also be in the physical form of a bead. The method of reducing or eliminating microbial contamination comprises, consists essentially of, or consists of treating the surface with the aforementioned composition of lithocholic acid, zinc pyrithione and cinnamaldehyde.

Lithochloic acid (LCA) herein is also reference to 3α-hydroxy-5p-cholan-24-oic acid and has the following general structure:

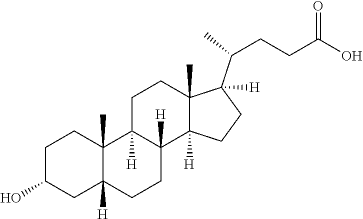

Zinc pyrithione (Zn) is a coordination complex of zinc and is also reference to bis(2-pyridylthio)zinc 1,1′-dioxide and has the following general structure:

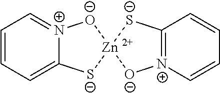

Cinnamaldehyde (CN) herein is also reference to (2E)-3-phenylprop-2-enal and has the following general structure:

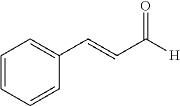

The composition herein as noted comprises, consists essentially of or consists of lithochloic acid, zinc pyrithione and cinnamaldehyde that is preferably dispersed in a matrix forming compound, such as a polymer resin to provide a coating or bead. A matrix forming compound may therefore be understood as a compound to disperse the lithocholic acid, zinc pyrithione and cinnamaldehyde, and provide for coating or bead formation, where the lithocholic acid, zinc pyrithione and cinnamaldehyde remain available in combination within the matrix compound to provide for antimicrobial activity. The lithocholic acid is therefore preferably present in the matrix compound at a level of 0.1 wt. % to 10.0 wt. %, including all values and increments therein, in 0.1 wt. % increments. The zinc pyrithione is preferably present in the matrix compound at a level of 0.1% (wt.) to 2.0% (wt.), including all values and increments therein, in 0.1 wt. % increments. The cinnamaldehyde is preferably present in the matrix compound at a level of 0.1 wt. % to 10.0 wt. %, including all values and increments therein, in 0.1 wt. % increments. The respective levels of each of lithocholic acid, zinc pyrithione and cinnamaldehyde are therefore preferably adjusted within these preferred ranges in the physical form of a polymer coating or polymer bead to then optimize anti-microbial performance within a selected microbial environment. The matrix compound may then account for the balance of the coating composition.

For the preparation of a coating, lithochloic acid, zinc pyrithione and cinnamaldehyde are preferably placed in a common solvent along with a polymer resin as the matrix compound that is therefore suitable for forming the coating. It is contemplated that the polymers may therefore include a variety of thermoplastic polymers or thermoset type polymers that are otherwise capable of serving as a coating medium for the lithocholic acid, zinc pyrithione and cinnamaldehyde. Such polymers may therefore preferably include polyolefins such as polyethylene, polypropylene, poly(vinylchloride), polyesters, polycarbonate, polysulfones, polyurethanes, acrylic polymers, silicones, thermoplastic elastomers, phenolic resins, epoxy resins, and natural and synthetic rubbers, and mixtures thereof.

Preferably, the solvent for coating formation is an amide type solvent, such as dimethylformamide (DMF) or dimethylacetamide (DMAc). It is also contemplated that one may utilize organosulfur type solvents, such as dimethylsulfoxide (DMSO). Preferably, the lithochloic acid, zinc pyrithione and cinnamaldehyde are placed in the solvent and stiffed and the mixture is then preferably sprayed on a substrate in need of anti-microbial treatment. Preferably, one may utilize nozzle size of 0.4 mm and the distance from the nozzle to the surface may be 3 cm to 5.0 cm. Coatings so formed are then preferably dried to remove solvent by heating. One may also utilize a dip coating procedure to coat a selected surface with the lithochloic acid, zinc pyrithione and cinnamaldehyde solvent mixture noted above, again followed by drying at elevated temperature.

Coatings so formed comprising, consisting essentially of or consisting of lithochloic acid, zinc pyrithione and cinnamaldehyde dispersed in a polymer preferably have a thickness in the range of 0.001 microns to 1000 microns (1.0 mm), including all values and increments therein, in 0.001 micron increments. The coatings, formed either by spraying or dip coating, may preferably be applied to a variety of substrate surfaces of varying geometry, including but not limited to glass, metals and polymeric type surfaces.

Optionally, the coating may contain another organic compound to contribute to the hydrophobicity of the coating and to absorb bacteria. One optionally and preferred organic compound in this regard comprises divinylbenzene (DVB). Other contemplated organic compounds include cinnamic acid, myristic acid, and polyethylene glycol.

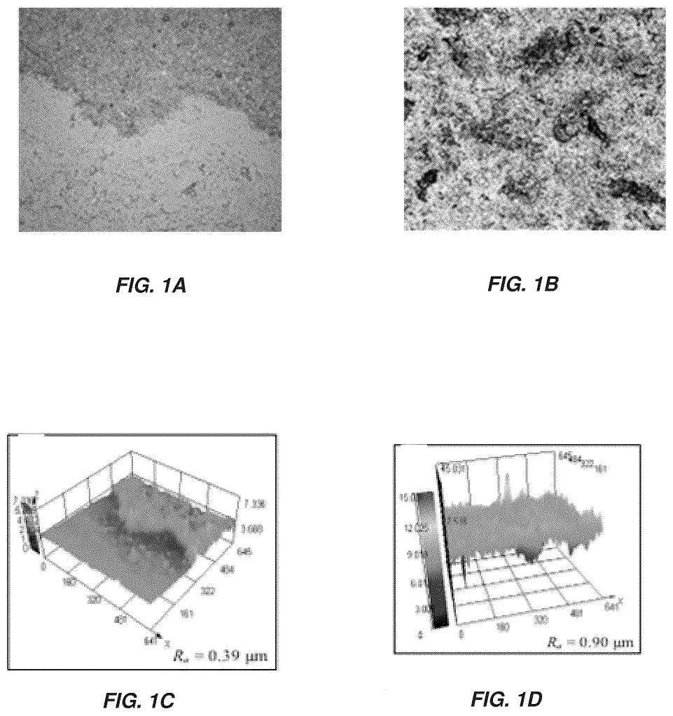

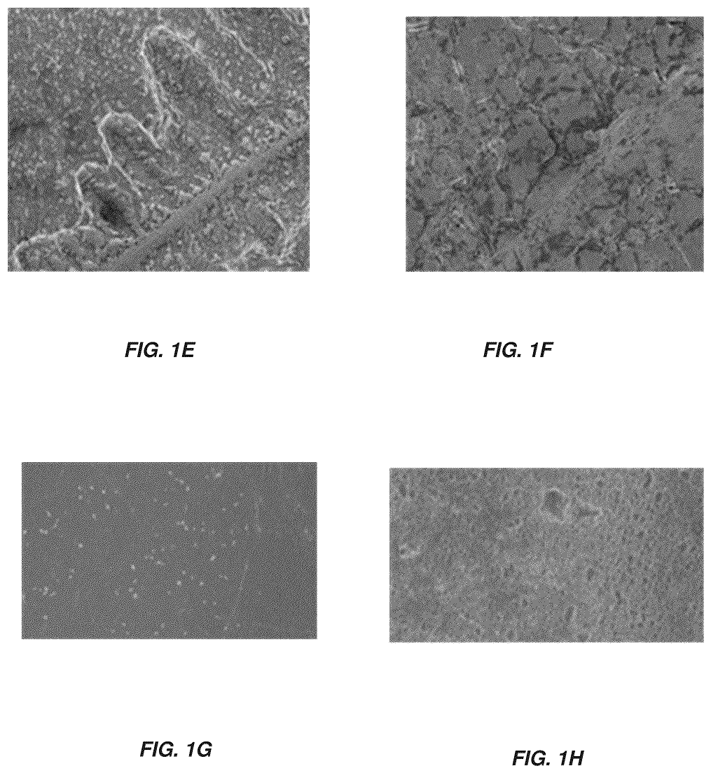

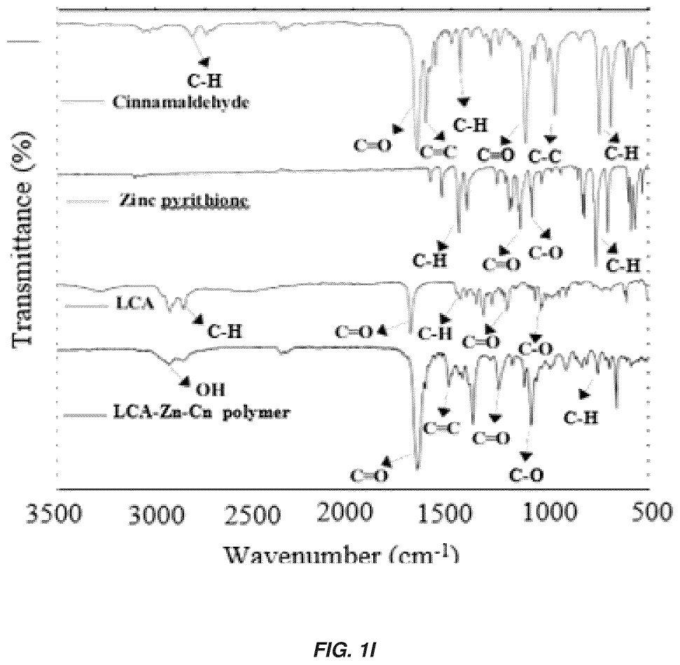

Attention is now directed to FIGS. 1A, 1B, 1C, 1D and 1E. FIG. 1A provides the confocal optical microscopy image of a formed biofilm on stainless steel with E. coli. FIG. 1B provides the confocal optical microscopy image of a formed biofilm on stainless steel with E. faecalis. FIGS. 1C and 1D shows the corresponding 3D images. FIG. 1E shows the SEM morphology of the formed biofilms with E. coli on glass and FIG. 1F shows the SEM morphology of E. faecalis on stainless steel. FIG. 1G and FIG. 1H show SEM images of the uncoated and a spray coated polyethylene substrate with the composition of lithocholic acid (5.0% wt.), zinc pyrthione (2.0% wt.) cinnamaldehyde (5.0% wt.) dispersed in an epoxy resin. As can be observed, the lithocholic acid, zinc pyrthione and cinnamaldehyde coating on polyethylene provides a relatively smooth surface with at about a preferred thickness of 30 μm to 40 μm.

The chemical composition and functional groups of the coating was checked using Fourier Transform Infrared Spectroscopy. See FIG. 1I. The characteristic benzene ring at 965 cm⁻¹, C=0 at 1667 cm⁻¹ and 1115 cm⁻¹, C═C bond at 1627 cm⁻¹, and aromatic C—H bond from the carbonyl group were found from the pure cinnamaldehyde. The zinc pyrithione showed the aromatic C—H bond around 763 cm⁻¹ and 1460-1540 cm⁻¹, and the carbonyl group C=0 at 1142 cm⁻¹. The C—H bond at 1536 cm⁻¹ depicts the coordination of oxygen atoms to Zn (blue). In the pure lithocholic acid, the peak at 2932 cm-1 corresponds to an alcohol bonded OH while the strong peak at 1704 cm⁻¹ indicates the existing C═O groups. Each component was found in the final LCA-Zn-Cn composite by adding epoxy and the optional component divinyl benzene. Specifically the strong peak centered at 1662 cm⁻¹ confirms the existing carbonyl group C=0. A few peaks of C-0 groups ranging from 1000 to 1230 cm⁻¹ originates from the epoxy backbone, which contributes to mechanical and chemical stability.

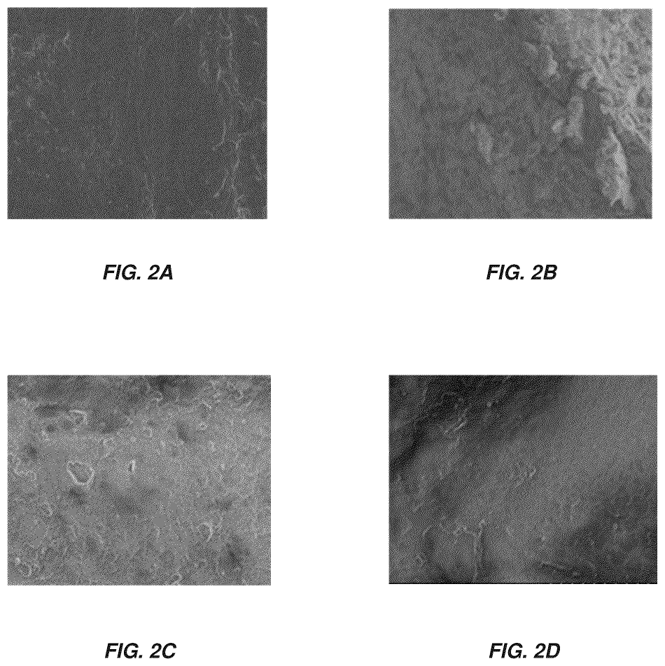

The biofilm prevention of lithocholic acid (LCA) in combination with zinc pyrithione (Zn) and cinnamaldehyde (CN) on coated silicone hose in tap water was then studied. In this particular example, the level of LCA was at 5.0 wt. %, Zn was present at 2.0 wt. % and CN was present at 5.0 wt. %, in an epoxy polymer. FIG. 2A shows the inside of silicon hose before treatment. A solution containing E. coli and E. faecalis was then passed through the silicone hose using a peristaltic pump at a flow rate of 5 mL min⁻¹ for 48 h. A clear thick biofilm was respectively formed inside the un-coated hose with both E. coli (FIG. 2B) and E. faecalis (FIG. 2C). However, no biofilm was observed inside the coated hose (FIG. 2D), which coating was prepared in accordance with the coating preparation noted herein. Accordingly, biofilm formation was successfully prevented by coating of the silicon hose with a composition of lithocholic acid, zinc pyrithione and cinnamaldehyde dispersed in this particular example in an epoxy resin.

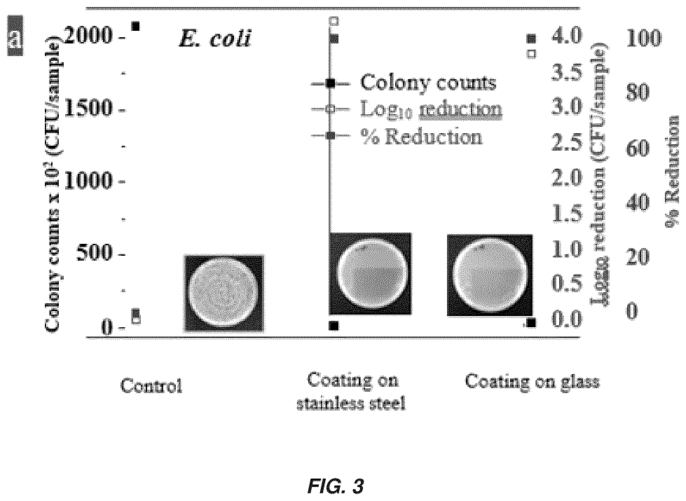

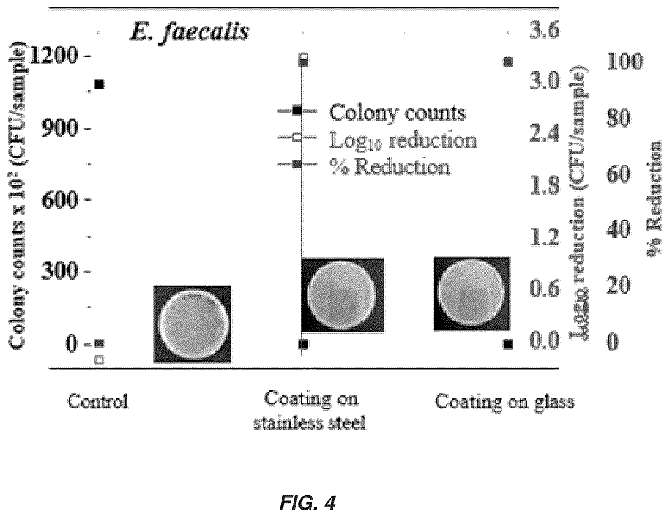

The antibacterial performance of the above referenced LCA-Zn-Cn coating was also separately checked with E. coli and E. faecalis in tap water by JIS Z 2801/ISO 22196 measurements. See FIG. 3 and FIG. 4. After 24 hours incubation, the total colonies of E. coli were reduced from 2.0×10⁵ to 12.0 CFU on stainless steel, which leads to a large reduction efficiency of >99% and a log₁₀ reduction of 4.23. The total colonies on glass were reduced from 2.0×105 to 35.0 CFU, which demonstrates a reduction efficiency of >99% and a log 10 reduction of 3.77. As a comparison, the E. coli amounts of the control sample increased from 2.4×104 to 2.0×105 CFU. As for the E. faecalis (FIG. 4) it was found that colonies of the control sample expanded from 1.8×104 to 1.0×105 CFU. However, the total colonies were largely decreased to 33.0 CFU with the coating on stainless steel and 37.0 CFU on glass, which corresponds to the efficiency of >99.5%, >99% and the log 10 reduction of 3.51, 3.46, respectively.

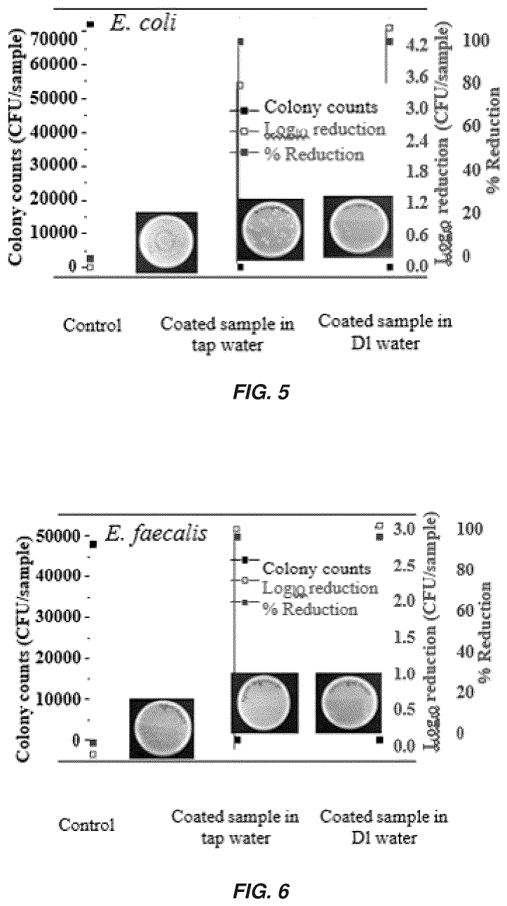

The antibacterial activity of the coating on commercial water meters was also checked in tap and de-ionized (DI) waters. As shown in FIG. 5 and FIG. 6, as high as >99% removal efficiency with the E. coli log₁₀ reduction of 3.45 in tap water, 4.55 in DI water and the E. faecalis log₁₀ reduction of 3.14 in tap water, 3.10 in DI water was obtained, respectively. The clearly increased log₁₀ reduction number for both E. coli and E. faecalis of the LCA-Zn-CN coating on different substrates demonstrates the excellent antimicrobial activity and relatively high flexibility.

As alluded to above, the LCA, Zn and CN may be dispersed in a matrix compound such as a polymer resin and be in the physical form of a bead. The bead preferably has a size in the range of 0.1 microns to 5000 microns (5.0 mm), including all values and increments therein. Beads can be formed by placing the LCA, Zn and CN in a solvent along with a selected polymer. The polymer may then preferably be selected from polyolefins such as polyethylene, polypropylene, poly(vinylchloride), polyesters, polycarbonate, polysulfones, polyurethanes, acrylics, silicones, thermoplastic elastomers, phenolic resins, epoxy resins, and natural and synthetic rubbers. The LCA, Zn and CN are then preferably dispersed throughout the bead. The beads are contemplated to be porous to therefore allow interaction of the LCA, Zn and CN with a given external medium in which they are placed.

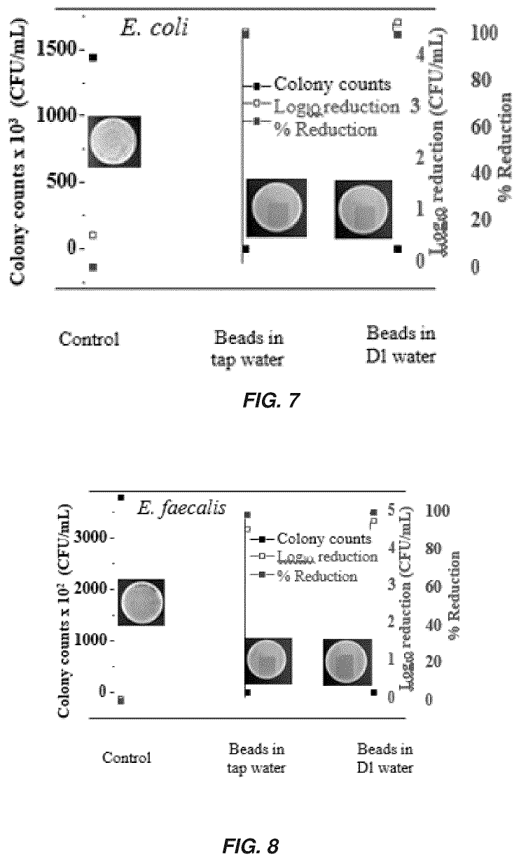

In one particular representative example, LCA, Zn and CN were dispersed in a polysulfone, where the LCA was present at 5.0 wt. %, Zn was present at 2.0 wt. % and CN was present at 5.0 wt. %. In a batch test the LCA-Zn-CN beads exhibited >99% removal efficiency for both E. coli (FIG. 7) and E. faecalis (FIG. 8). The corresponding log₁₀ reduction is 4.7 in tap water, 4.65 in DI water for E. coli and 4.50 in tap water and 4.71 in DI water for E. faecalis.

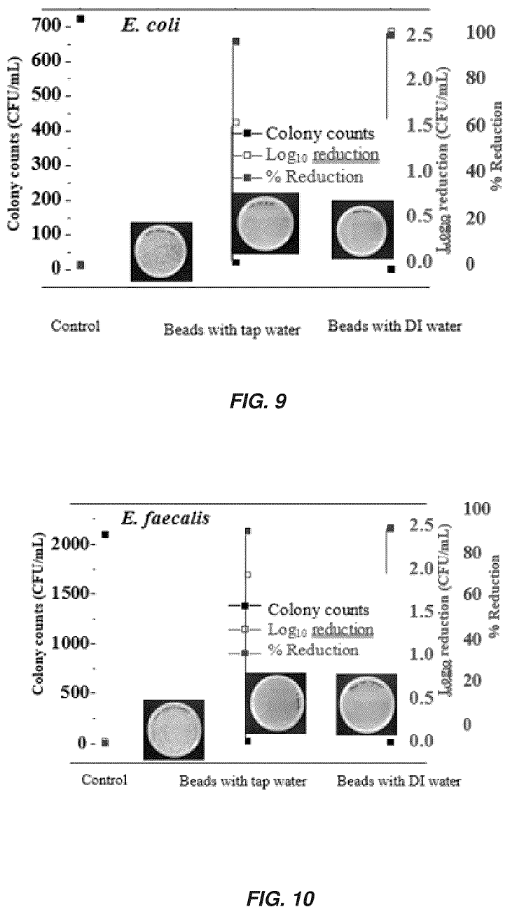

The LCA, Zn, CN beads in continuous column tests also showed a relatively high E. coli removal efficiency of 97% in tap water, 99% in deionized water with the log 10 reduction of 1.55 in tap water, 2.55 in deionized water. See FIG. 9. FIG. 10 displays the E. faecalis removal efficiency of 98% in tap water, 99% in DI water and the log 10 reduction of 1.92 in tap water, 2.47 in DI water, respectively. Similar to the E. coli data, the control sample presented a relatively high increase in the colonies.

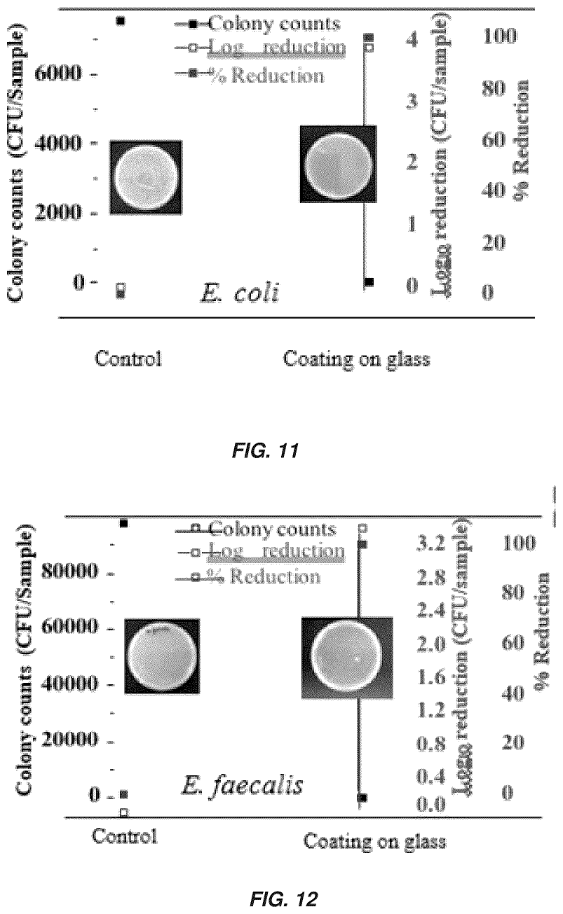

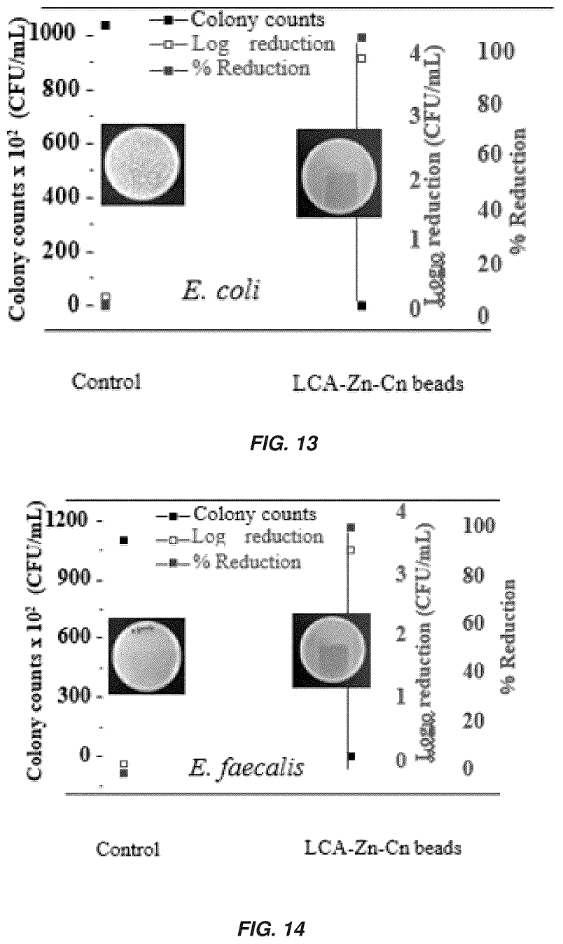

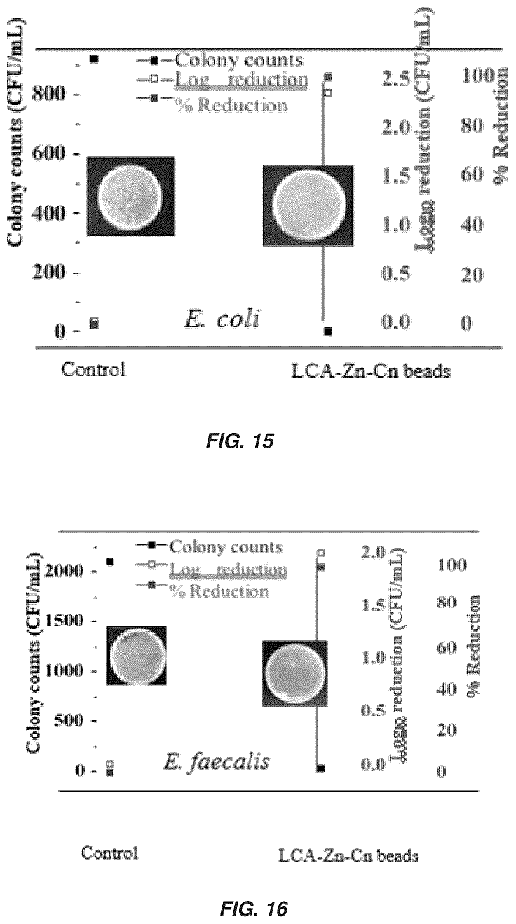

To further validate the antimicrobial activity of the LCA-Zn-Cn coating in natural water, Lake Michigan water was investigated. During the JIS Z 2801/ISO 22196 test, the coating on glass after 24 h incubation exhibited a log₁₀ reduction of 3.87 with E. coli (FIG. 11) and 3.42 with E. faecalis (FIG. 12), respectively. In the batch study, the LCA-Zn-Cn beads showed a log 10 reduction of 3.87, removal efficiency of >99% with E. coli (FIG. 13) and a log 10 reduction of 3.42, removal efficiency of >99% with E. faecalis, respectively (FIG. 14). Column tests also showed high removal efficiency of 99% for both E. coli (FIG. 15) and E. faecalis (FIG. 16) with a relatively high log 10 reduction. These bacteria inhibition results confirmed the LCA-Zn-CN polymer has high bacteria prevention capability under interferences in real water system.

Without being bound by theory, it appears that the antibacterial activity of the LCA-Zn-CN polymer coating and/or beads, results from the combined effect of the LCA-Zn-CN ingredients and mechanical reliability is provided by the presence of the selected polymer. The coating appears to attract bacteria through a hydrophobic interaction. Then the LCA-Zn-CN may diffuse/penetrate through the bacteria membrane causing membrane depolarization, cytoplasmic leakage and morphology distortion, leading to bacteria death. As a result, the subsequent colonization of pathogenic bacteria, examples of which are E. coli and E. faecalis are inhibited, and the potential for biofilm formation is mitigated or prevented.

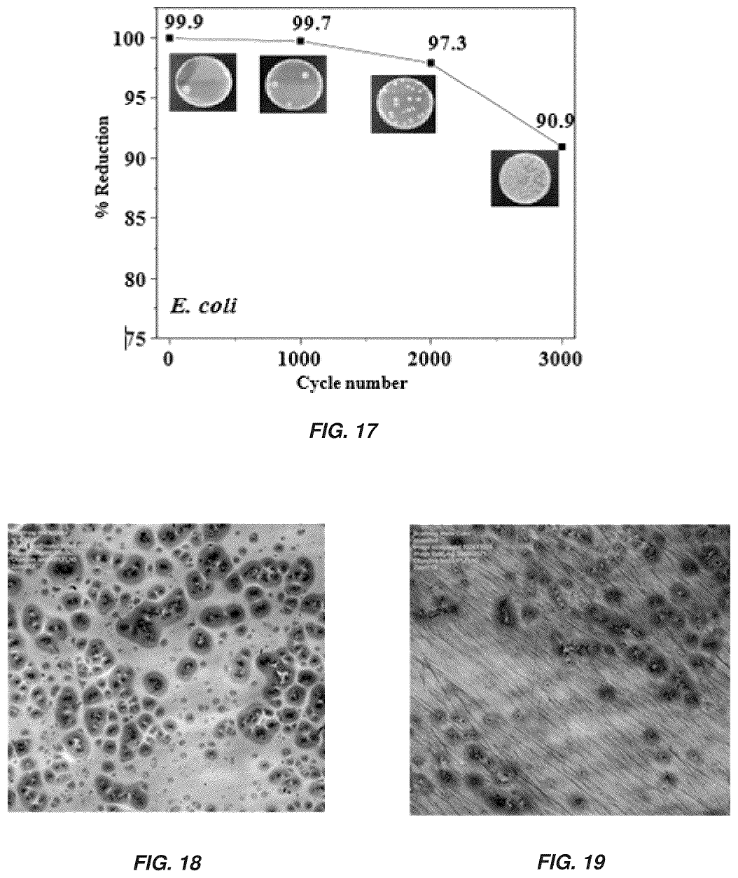

The polymer selection that is employed within the film or in the bead serves as a supporting medium and provided mechanical integrity to the film and bead. The mechanical property of the coating on glass after abrasion was measured by using sandpaper under a pressure of 9.8 kPa. The durability of antimicrobial performance with initial E. coli concentration of 2.03×10⁵ CFU was checked after each abrasion cycle. As shown in FIG. 17 over 99.7% of the bacteria were inhibited after 1000 cycles. Even after 3000 cycles, more than 90.9% of the bacteria were prevented. FIG. 18 shows coating morphology before abrasion and FIG. 19 shows coating morphology after abrasion. The coating morphology after abrasion appears to be similar to the coating morphology before abrasion.

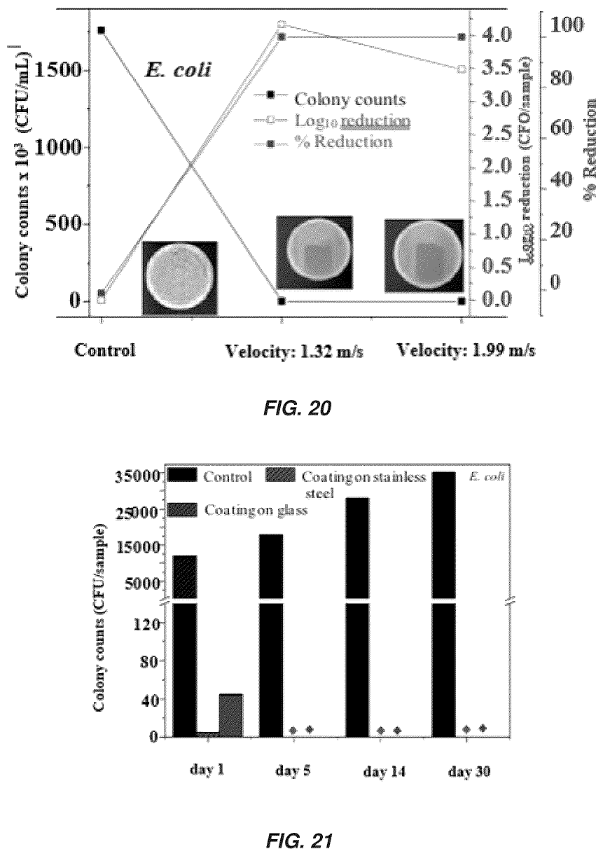

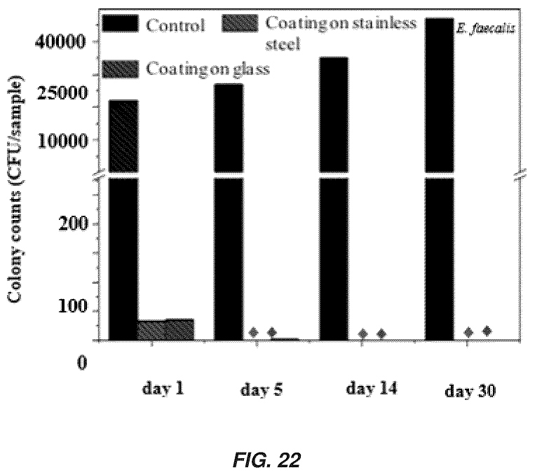

The corresponding antibacterial activity of E. coli was validated using the JIS Z 2801/ISO 22196 measurement. It was found that relatively large log₁₀ reductions of 4.16 and 3.49 were respectively received after 50 L tap water flushing under flow velocities of 1.32 and 1.99 m/s (FIG. 20), which confirms the high durability of the coating. The long-term antimicrobial behaviour of the coating on stainless steel and glass against E. coli and E. faecalis was studied via the JIS Z 2801/ISO 22196 method. E. coli (FIG. 21) and E. faecalis (FIG. 22) were expanded from 1.8×10³ and 3.5×10⁴ CFU to 3.2×10⁴ and 4.7×10⁴ CFU after 30 days. However, the colonies on coated stainless steel and glass were reduced from 1.8×10³ CFU to zero only after 5 days. No further bacteria were observed up to 30 days.

It was also separately confirmed that the coatings herein may be applied to irregular surfaces such as drains and water meters. Both spray and dip coating was successfully employed to apply the LCA-Zn-CN coating on a variety of surfaces including plastic, metals, ceramic. In addition, as alluded to above, the LCA-Zn-CN coating can be applied to the inner surfaces of tubular structures such as silicon hose and polymeric pipes, where dip coating is preferred.

Materials

Lithocholic acid (C₂₄H₄₀0₃, ≥95%), Zinc Pyrithione (C₁₀H₈N₂0₂S₂Zn, 96%), trans-cinnamaldehyde (C₆H₅CH═CHCH0, 99%), ethanol (CH₃CH₂OH, ≥99.7%), polysulfone ([C₆H₄-4-C(CH₃)₂C₆H₄-4-0C₆H₄-4-S0₂C₆H₄-4-0]ₙ, 100%), poly(bisphenol A-coepichlorohydrin) glycidyl end-capped resin (Mn: 377 g/mol, 99%), divinylbenzene (C₆H₄(CH═CH₂)₂, 80%) and N,N-dimethylformamide (HCON(CH₃)₂, 99.8%) were purchased from Sigma-Aldrich. Partial stainless-steel samples were provided by Badger Meter, Inc.

Example Methods for Coatings and Beads

Example preparation of a LCA-Zn-CN coating. In a typical experiment, 1.2 g of poly(bisphenol A-coepichlorohydrin) glycidyl end-capped resin (epoxy) having a Mn value of 1075 was dissolved in a solution of 6 mL dimethylformamide (DMF), 1 mL divinylbenzene (DV B), 1.0 mL cinnamaldehyde (CN), 0.1 g zinc pyrithione and 0.27 g lithocholic acid (LCA). The mixture solution was stirred under 60 rpm (Magnetic stirrer. Thermo Scientific) at room temperature for 2 h. The obtained solution was sprayed on different substrates such as stainless steels, plastics, polyethylene surface and glasses by using an airbrush makeup kit. The nozzle size is 0.4 mm and the distance from nozzle to the surface is 4 cm. The spraying time was controlled within 10 to 12 seconds under a pressure of 25 Psi. The coated sample was transferred to an oven and dried at 80° C. for 5 h. Dip coating process: The water devices such as silicone hose were dipped in to the received polymer solution for 15 min. Then the sample was dried at 80° C. for 5 h.

Other coating formulation made according to the above general procedure, using eoxy resin as the preferred polymer component, along with their associated Log₁₀ reduction performance on stainless steel and glass, to either E. Coli or E. faecalis, are illustrated in Table 1:

TABLE 1
LCA-Zn-CN Coatings

| | | E. coli | | E. faecalis | |
|---|---|---|---|---|---|
| | Weight | Log₁₀ reduction | | Log₁₀ reduction | |
| Coatings | Percentage | Stainless | Glass | Stainless | Glass |
| Materials | (%) | steel | slide | steel | slide |
| Lithocholic acid | LCA: 5.0 | 2.68 | 3.01 | 2.54 | 2.98 |
| (only) | | | | | |
| Cinnamaldehyde | Cn: 5.0 | 2.54 | 2.66 | 2.86 | 3.05 |
| (only) | | | | | |
| LCA-Cn | LCA: 5.0, | 3.30 | 2.68 | 2.73 | 3.11 |
| | Cn: 5.0 | | | | |
| LCA-Zn | LCA: 5.0, | 3.77 | 3.83 | 3.14 | 2.68 |
| | Zn: 2.0 | | | | |
| LCA-Cn-Zn | LCA: 5.0, | 4.23 | 3.77 | 3.51 | 3.46 |
| | Zn: 2.0, | | | | |
| | Cn: 5.0 | | | | |

Sample preparation of LCA-Zn-CN heads. 18 wt % polysulfone (PSF) was dissolved in 70 wt % 1-methyl-2-pyrrolidone (NMP) in a round bottom flask. The solution was kept refluxing with circulated water on a hot plate under 90° C. and 80 rpm for 6 h. Subsequently, 5.0 wt % LCA, 5.0 wt % Cn and 2.0 wt % Zn were added and kept refluxing at 80° C., 80 rpm for another 12 h. After the reaction, the mixture solution was slowly dropped into 1000 mL DI water solution using 1.0 mL pipette at 27° C. After 2 h, the LCA-Zn-Cn beads were collected.

Other bread formulations made according to the above general procedure using polysulfone as the preferred polymer component, along with their associated Log₁₀ reduction performance, to either E. Coli or E. faecalis, in a batch study, are illustrated in Table 2:

TABLE 2
LCA-Zn-CN Beads

| | Weight | Weight | Weight | | |
|---|---|---|---|---|---|
| | percentage | percentage | percentage | Log₁₀ reduction | |
| Beads (Batch study) | of LCA (%) | of Zn (%) | of CN (%) | E. coli | E. faecalis |
| Material (LCA-CN- Zn): | 3.4 | 2.0 | 5.0 | 3.10 | 2.15 |
| Lithocholic acid | 5.0 | 2.0 | 5.0 | 3.55 | 3.47 |
| (LCA) | 6.4 | 2.0 | 5.0 | 3.56 | 3.45 |
| Zinc pyrithione (Zn) | 5.0 | 0 | 5.0 | 2.73 | 2.68 |
| Cinnamaldehyde (CN) | 5.0 | 2.0 | 5.0 | 3.56 | 3.45 |
| | 5.0 | 3.0 | 5.0 | 3.55 | 3.41 |
| | 5.0 | 2.0 | 0 | 3.14 | 3.11 |
| | 5.0 | 2.0 | 5.0 | 3.56 | 3.45 |
| | 5.0 | 2.0 | 6.0 | 3.53 | 3.45 |

Table 3 below shows additional batch studies on beads formed as noted above with polysulfone and with individual or combined amounts of LCA, Zn and CN, to show the relative synergy and combined effect of LCA-Zn-CN with respect to antimicrobial performance:

TABLE 3

| Beads (Batch study) | | Log₁₀ reduction | |
|---|---|---|---|
| Materials | Weight percentage (%) | E. coli | E. faecalis |
| Lithocholic acid | LCA: 5.0 | 2.18 | 2.15 |
| (only) | | | |
| Cinnamaldehyde | Cn: 5.0 | 2.15 | 2.34 |
| (only) | | | |
| LCA-Cn | LCA: 5.0, Cn: 5.0 | 2.73 | 2.68 |
| LCA-Zn | LCA: 5.0, Zn: 2.0 | 3.14 | 3.11 |
| LCA-Cn-Zn | LCA: 5.0, Zn: 2.0, Cn: 5.0 | 3.55 | 3.47 |

Characterization

A 3D laser confocal microscope (Olympus LEXT 0LS4100, Japan) was used to collect the 3D surface morphology and roughness information. Fourier transform infrared spectrometer (FTIR, Shimadzu IRTracer-100) was used to analyze the chemical composition and functional groups. Ultra-high-resolution field emission scanning electron microscope (FESEM, Hitachi S4800) was used to check the surface morphology and thickness of the sample. The pH value of the water was tested by using a pH meter (FiveEasy Benchtop F20 pH/mV Standard Kit, Mettler Toledo). The bacteria concentration was studied by using a UV Visible spectrophotometer (Evolution 201, Thermo Fisher Scientific). The bacteria were cultured inside an incubator with mechanical convection (Thermo Scientific Precision 6LM). The morphology of colonies was recorded via digital camera.

Antibacterial Testing

The bacteria of E. coli (ATCC 15597, gram negative) and E. faecalis (ATCC 29212, gram positive) were used as representative microorganisms to test the antibacterial activity. All the bacteria were stored at a frozen temperature of −80° C. The bacteria were grown overnight at 37° C. with Luria-Bertani broth (LB) in the incubator prior to experiments. To determine the concentration, the selected bacteria were placed in 5 mL of LB broth overnight under mechanical stirring at 100 rpm. Then the concentration was quantified by measuring the UV absorbance at 600 nm (OD₆₀₀) via a UV Visible spectrophotometer (Evolution 201, Thermo Fisher Scientific).

JTS Z 2801/TSO 22196 (Japanese Industrial Standard). Certain amounts of E. coli were suspended in 5 mL of LB broth for incubation and adjusted to 1.2×10⁸ CFU mL⁻¹ by reaching the OD₆₀₀ value of 0.6. Similarly the E. faecalis was adjusted to 9×10⁷ CFU mL⁻¹ by reaching the OD₆₀₀ value of 0.9. The received solution was further diluted 1000 times, obtaining the final concentration of 1.2×10⁵ CFU mL⁻¹ for E. coli of and 9×10⁴ CFU mL⁻¹ for E. faecalis, respectively. Subsequently 200 μL of suspension was smeared on the target surface. The total E. coli is 2.4×10⁴ CFU/200 μL and the total.

E. faecalis is 1.8×10⁴ CFU/200 μL. Then a 40×40 mm² cover slip was placed to ensure close contact between the suspension and coating. After 24 h incubation at 37° C., the coating sample and cover slip were carefully washed with 10 mL sterilized distilled water followed by a mechanical agitation (Compact digital mini rotator, 100 rpm, Thermo Scientific) for 25 min. Subsequently 100 μL above solution was plated on a 2% LB agar plate. The sample was incubated inside the incubator at 37° C. for 24 h. Finally the microbial colonies were counted by using standard plate count (SPC) method. The sterilized distilled water was obtained by treating 1.0 L DI water in a consolidated sterilizer system (SR-24D-ADVPR02, D.A.I. Scientific Equipment) at 121° C. for 15 min.

Antibacterial test inside a silicone hose. A 30 cm long silicone hose (inner diameter: 0.64 cm) was placed on a peristaltic pump (Cole-Parmer-Model-77200-30, Masterflex US), as shown in FIG. 1b. One side of the silicone hose (10 cm) was covered by the LCA-Zn-Cn coating via dip-coating while another side remained un-coated. Then a designed bacteria solution was passed through the hose. After test, the inner surface was analyzed by SEM and JIS Z 2801/ISO 22196 methods.

Batch study. The bacteria of E. coli and E. faecalis were cultured in a 5 mL LB broth at 37° C. for 24 h. LB broth: 10 g L⁻¹ Tryptone, 5 g L⁻¹ yeast extract, 10 g L⁻¹ NaCl. The stock bacteria concentration: E. coli: 4.2×10⁷ CFU mL⁻¹; E. faecalis: 1.0×10⁷ CFU mL⁻¹. Then 1.0 mL of the suspension was added into a 100 mL sterilized distilled water in a beaker, obtaining concentrations of 4.2×10⁵ CFU mL⁻¹ for E. coli and 1.0×10⁵ CFU mL⁻¹ for E. faecalis. 2.0 g L⁻¹ of LCA-Zn-Cn beads were added into the solution. The bacteria incubation was completed under 120 rpm shaking inside the incubator at room temperature for 24 h. Finally 100 μL solution was collected and plated on a 2% LB agar plate. After incubation at 37° C. for 24 h, the colonies were counted by SPC.

The bacteria removal efficiency (reduction %) and log₁₀ reduction were calculated by the following equations:

R=C₀−Cₑ/C₀×100% (1)

Log₁₀reduction=Log₁₀B−Log₁₀C (2)

where R is the bacterium removal efficiency. Co and Ce are the initial and final bacterium concentrations. B is the total colony amount after incubation without the coating and C is the final colony amount after incubation with the coating.

Continuous column study. A 1.0 mL E. coli culture solution in the mid-exponential growth phase was adjusted to 1.2×10⁸ CFU mL⁻¹ by using a UV absorbance with OD₆₀₀ of 0.6. The E. faecalis concentration was also adjusted to 9×10⁷ CFU mL⁻¹ by reaching the OD₆₀₀ value of 0.9. Then the sample was diluted to a final concentration of 720 CFU mL⁻¹ for E. coli and 2100 CFU mL⁻¹ for E. faecalis in 1.0 L water with pH 7.2, respectively. 2.0 g LCA-Zn-Cn beads were placed inside a glass column with 1.5 cm inner diameter and 20 cm height, which is connected to a pump (Cole-Parmer-Model-77200-30, Masterflex L/S) to control the inlet flow rate. The experiment was conducted by pumping the microbial contaminated water into the column in an up-flow mode with a flow rate of 25 mL min-. The collected effluent was spread on a 2% LB agar plate, followed by incubation at 37° C. for 24 h. Finally the obtained colonies were counted using the SPC technique. The control sample was prepared under the same process except the beads contact.

Lake Michigan water analysis. (1) JIS Z 2801/ISO 22196 measurement. The stock bacterium concentration: E. coli: 6.4×10⁶ CFU mL⁻¹, E. faecalis: 9.0×10⁶ CFU mL⁻¹. Upon dilution with Lake Michigan water, the concentration of 6.4×10⁵ CFU mL⁻¹ for E. coli and 9.0×10⁵ CFU mL⁻¹ for E. faecalis was respectively received. Then 200 μL solution (E. coli: 1.28×10⁴ cells/200 μL or E. faecalis: 1.8×10⁴ cells/200 μL) was smeared on the LCA-Zn-Cn coated glass. The surface was covered by a cover slip. Then the sample was incubated in the incubator at 37° C. for 24 h. After the incubation, the cover slip and glass were placed inside a glass container with 10 mL sterilized distilled water. After a mechanical agitation by a compact digital mini rotator (Thermo Scientific) for 25 min, 100+L sample was plated on a 2% LB agar plate and incubated inside the incubator at 37° C. for 24 h. The final colonies were counted using the SPC method. (2) Batch study. The E. coli and E. faecalis were cultured in a 10 mL Luria-Bertani broth at 37° C. for 24 h. Then a 1.0 mL solution was adjusted by using a UV OD₆₀₀ absorbance of 0.5 for E. coli and 0.9 for E. faecalis, corresponding to the concentration of 1.0×10⁸ and 1.1×10⁸ CFU mL⁻¹, respectively. Then the sample was diluted to a final concentration of 1.0×10 CFU mL⁻¹ for E. coli and 1.1×10⁵ CFU mL⁻¹ for E. faecalis with the Lake Michigan water, respectively. 0.2 g of LCA-Zn-Cn beads were added into the 100 mL solution. The bacteria incubation was completed under 120 rpm shaking at 37° C. for 24 h. Finally 100 μL solution was collected and plated on a 2% LB agar plate. After 24 h incubation at 37° C., the colonies were counted by SPC method. (3) Continuous column study. The bacteria solution was first diluted to a concentration of 920 CFU mL⁻¹ for E. coli and 2100 CFU mL⁻¹ for E. faecalis in 1.0 L Laker Michigan water with pH 7.6, respectively. 2.0 g LCA-Zn-Cn beads were added to a column with 1.5 cm of inner diameter and 20 cm of height. The experiment was conducted by pumping the bacteria contaminated water into the column in an up-flow mode with a flow rate of 25 mL min⁻¹. The water effluent was spread on a 2% LB agar plate, followed by incubation at 37° C. for 24 h. In the last step, the obtained colonies were counted using the SPC method. The control sample was treated under the same process except the beads contact.

Durability Tests

Abrasion test. An abrasion test for the LCA-Zn-Cn coating on glass was done using a sandpaper (grit No. 800) under a pressure of 9.8 kPa. The sandpaper was placed facedown to the coated surface. A metal ingot with a 100.0 g standard weight was placed on the topside of the sandpaper. For each cycle, the coating sample was moved forward and backward 10 cm. The antibacterial performance was measured after abrasion cycles via the JIS Z 2801/ISO 22196 measurement. 200 μL of E. coli solution with a concentration of 1.01×10⁶ CFU mL⁻¹ was smeared on the sample surface. The total amount of E. coli is 2.03×10⁵ cells/200 μL.

The flow velocity test. 50 L of tap water with a pH of 7.2 was flowed through a silicone hose (inner diameter: 0.64 cm, length: 10 cm) inside wall coated with LCA-Zn-Cn at a rate of 1.32 m/s and 1.99 m/s, respectively. Then the antibacterial activity of the inner surface was evaluated by using E. coli via the JIS Z 2801/ISO 22196 measurement. A control sample without the LCA-Zn-Cn coating was also tested under same conditions.

Long-term antimicrobial activity test. Long-term antimicrobial activity of the coating was checked via the JIS Z 2801/ISO 22196 method. The stock bacterium concentration: E. coli: 1.5×10⁴ CFU mL⁻¹, E. faecalis: 2.5×10⁴ CFU mL⁻¹. Then 100 μL solution (E. coli: 1.5×10³ cells/100 μL or E. faecalis: 2.5×10³ cells/100 μL) was smeared on the LCA-Zn-Cn coated stainless steel, glass and control samples, respectively. The surface was covered by a cover slip. Then the sample was incubated in the incubator at 37° C. for 30 days. During the incubation, the sample was taken out and added 10 mL sterilized distilled water in a beaker. After mechanical agitation for 25 min, 100 μL sample was plated on a 2% LB agar plate and incubated at 37° C. for 24 h. The final colonies were counted using the SPC method.

1. An antimicrobial composition comprising lithocholic acid, zinc pyrithione, cinnamaldehyde and a matrix forming compound.

2. The antimicrobial composition of claim 1 wherein lithochocholic acid is present at a level of 0.1 wt. % to 10.0 wt. %, zinc pyrithione is present at a level of 0.1 wt. % to 2.0 wt. %, and cinnamaldehyde is present at a level of 0.1 wt. % to 10.0 wt. %.

3. The antimicrobial composition of claim 1 wherein the matrix forming compound comprises a polymer.

4. The antimicrobial composition of claim 3 wherein said polymer is selected from the group consisting of polyolefins, poly(vinyl chloride), polyesters, polycarbonate, polysulfones, polyurethanes, acrylic polymers, silicone, thermoplastic elastomers, phenolic resins, epoxy resins, natural and synthetic rubbers, and mixtures thereof.

5. The antimicrobial composition of claim 1 wherein the composition is in the form of a coating.

6. The antimicrobial composition of claim 1 wherein the coating has a thickness in the range of 0.001 micron to 1000 microns.

7. The antimicrobial composition of claim 1 wherein the composition is in the form of a bead having a size in the range of 0.1 microns to 5000 microns.

8. A method of preventing or reducing the accumulation of biofilm on a surface, the method comprising coating the surface with an antimicrobial composition comprising lithocholic acid, zinc pyrithione, cinnamaldehyde and a matrix forming compound.

9. The method of claim 5 wherein lithchocholic acid is present at a level of 0.1 wt. % to 10.0 wt. %, zinc pyrithione is present at a level of 0.1 wt. % to 2.0 wt. %, and cinnamaldehyde is present at a level of 0.1 wt. % to 10.0 wt. %.

10. The method of claim 5 wherein the matrix forming compound comprises a polymer.

11. The method of claim 7 wherein said polymer is selected from the group consisting of polyolefins, poly(vinyl chloride), polyesters, polycarbonate, polysulfones, polyurethanes, acrylic polymers, silicone, thermoplastic elastomers, phenolic resins, epoxy resins, natural and synthetic rubbers, and mixtures thereof.

12. A method of treating water comprising contacting water with a composition comprising lithocholic acid, zinc pyrithione, cinnamaldehyde in a matrix forming compound.

13. The method of claim 12 wherein said composition comprises lithochocholic acid at a level of 0.1 wt. % to 10.0 wt. %, zinc pyrithione at a level of 0.1 wt. % to 2.0 wt. %, and cinnamaldehyde at a level of 0.1 wt. % to 10.0 wt. %.

14. The method of claim 12 wherein the matrix forming compound comprises a polymer.

15. The method of claim 14 wherein said polymer is selected from the group consisting of polyolefins, poly(vinyl chloride), polyesters, polycarbonate, polysulfones, polyurethanes, acrylic polymers, silicone, thermoplastic elastomers, phenolic resins, epoxy resins, natural and synthetic rubbers, and mixtures thereof.

16. The method of claim 12 wherein the composition is in the form of a coating.

17. The method of claim 16 wherein the coating has a thickness in the range of 0.001 micron to 1000 microns.

18. The method of claim 12 wherein the composition is in the form of a bead having a size in the range of 0.1 microns to 5000 microns.
